(19) United States
(12) Patent Application Publication
(10) Pub. No.: US 2017/0228706 A1
(43) Pub. Date: Aug. 10, 2017

(54) SYSTEM FOR RESOURCE ACCUMULATION TRIGGERING BASED ON AMOUNT WITHIN AN INTERVAL

(71) Applicant: Bank of America Corporation, Charlotte, NC (US)

(72) Inventors: Carl Parziale, Charlotte, NC (US); Kerry M. Cantley, Fort Mill, SC (US)

(21) Appl. No.: 15/018,433

(22) Filed: Feb. 8, 2016

(51) Int. Cl. G06Q 20/10

(52) U.S. Cl. CPC G06Q 20/10

(57) ABSTRACT

Embodiments of the present invention provide a system for triggering alerts to accumulate system resources in response to deposit amounts exceeding a threshold. The system determines a threshold deposit amount based on a regulatory amount of deposited funds that must occur during a regulatory period before a report must be provided to a regulatory agency. The system accumulates deposit data to create a deposit database. When the system receives a request for a new deposit associated with a new deposit amount and a user, the system can identify previous related deposits by searching the deposit database. The system may then combine an amount of the previous deposits with the new deposit amount to determine a total deposited amount. If the total deposited amount exceeds the threshold deposit amount, then the system will request additional regulatory information associated with the deposits before processing the deposit.

### FIELD OF THE INVENTION

The present invention is generally directed to a system for resource accumulation triggering, based on one or more amounts identified within an interval.

### BACKGROUND

Regulatory agencies often require an entity to file a report based on how actions of one or more of the entity's customers within a certain period of time. This task for the entity becomes more difficult when the reports are required in response to an accumulation of different activities by one or more of the entity's customers, because tracking such different activities can be difficult and/or burdensome for the entity. Additionally, the entity may need to acquire information from these one or more customers for the purpose of including an accurate report to the regulatory agency. Furthermore, it may be in the entity's and/or the regulatory agency's interest for the entity to identify when a report is required and to file the report in an expedient and efficient manner.

Therefore, a need exists to allow an entity to identify activities that may subsequently be accumulated to trigger a regulatory report in real time, before the report is required, such that the entity may begin to acquire any pertinent information from a customer in preparation for the report.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for triggering alerts associated with deposit amounts. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. The system may involve determining a threshold deposit amount based on a regulatory amount of deposited funds during any calendar day that triggers a requirement for a financial institution to notify a regulatory agency, wherein the threshold deposit amount is less than the regulatory amount. Additionally, the embodiments of the system may receive deposit data in real time and store the deposit data in a deposit database. Furthermore, the system may receive a request for a new deposit associated with a new deposit amount and a user. In some embodiments, the system may identify a previous deposit by the user by searching the deposit database, wherein the previous deposit occurred earlier on a same calendar day. Additionally, the system may combine an amount of the previous deposit with the new deposit amount to determine a total amount deposited by the user during the same calendar day and determine that the total amount exceeds the threshold deposit amount. Furthermore, in some embodiments, the system may request regulatory information of the user and receive the regulatory information of the user before the system processes the deposit.

In some embodiments, the system may determine that the total amount deposited by the user during the same calendar day exceeds the regulatory amount, and automatically transmit a report comprising the regulatory information of the user to the regulatory agency.

Furthermore, in some embodiments, the system may determine the threshold deposit amount based on a percentage of or a predetermined amount less than the regulatory amount of deposited funds during any calendar day that triggers a requirement for a financial institution to notify a regulatory agency. Alternatively, the system may determine the threshold deposit amount based on a deposit trend that indicates that the threshold deposit amount would be exceeded if the deposit trend continues.

Additionally, in some embodiments, the system may identify a first person on whose behalf the new deposit is being conducted, and identify a previous deposit for the first person by searching the deposit database, wherein the previous deposit occurred earlier on a same calendar day. The system may then combine an amount of the previous deposit with the new deposit amount to determine a total amount deposited for the first person during the same calendar day and determine that the total amount deposited for the first person exceeds the threshold deposit amount. Finally, the system may request regulatory information for the first person, receive the regulatory information for the first person, and process the deposit.

In some embodiments, the system may identify a first account to which the new deposit is being conducted and identify a previous deposit for the first account by searching the deposit database, wherein the previous deposit occurred earlier on a same calendar day. Additionally, the system may combine an amount of the previous deposit with the new deposit amount to determine a total amount deposited for the first account during the same calendar day and determine that the total amount deposited for the first account exceeds the threshold deposit amount. Furthermore, the system may request regulatory information associated with the first account, receive the regulatory information associated with the first account, and process the deposit.

Finally, in some embodiments, the system may transmit a command to a user interface of a computing device at a location of the request for the new deposit, causing the user interface to display a selectable offer to open an investment account to which the deposit amount may be transferred, receive an indication from the user interface that the user selected the offer, and transmit the deposit amount to the investment account.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for triggering alerts associated with deposit amounts, in accordance with an embodiment of the invention;

FIG. 2 provides a block diagram illustrating the personal computing device of FIG. 1, in accordance with an embodiment of the invention;

FIG. 3 provides a block diagram illustrating the financial institution system of FIG. 1, in accordance with an embodiment of the invention;

FIG. 4 provides a block diagram illustrating the transaction computing device of FIG. 1, in accordance with an embodiment of the invention;

FIG. 5 provides a block diagram illustrating the deposit database system of FIG. 1, in accordance with an embodiment of the invention;

FIG. 6A is a diagram illustrating a centralized clearinghouse network configuration, in accordance with embodiments of the invention;

FIG. 6B is a diagram illustrating a decentralized block chain network configuration, in accordance with embodiments of the invention; and

FIG. 7 provides a flowchart illustrating a process for triggering alerts associated with deposit amounts, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” and “financial entity” include any organization that processes financial transactions including, but not limited to, banks, credit unions, savings and loan associations, investment companies, stock brokerages, asses management firms, insurance companies and the like. In specific embodiments of the invention, use of the term “bank” is limited to a financial entity in which account-bearing customers conduct financial transactions, such as account deposits, withdrawals, transfers and the like.

Embodiments of the present invention provide a system and method for triggering alerts to accumulate system resources, in response to determining that deposit amounts are approaching a threshold that requires submitting a report to a reporting agency. The system determines a threshold deposit amount based on a regulatory amount of deposited funds that must occur during a regulatory period before a report must be provided to the regulatory agency. The system accumulates deposit data from multiple, different sources to create a deposit data reference database. The system then receives a request for a new deposit associated with a new deposit amount and a user and identify a previous deposit by the user through searching the deposit database for similar deposits from the same regulatory period. The system may then combine an amount of the previous deposits with the new deposit amount to determine a total deposited amount for the regulatory period. If the total deposited amount exceeds the threshold deposit amount, then the system will request additional regulatory information associated with the deposits before processing the deposit.

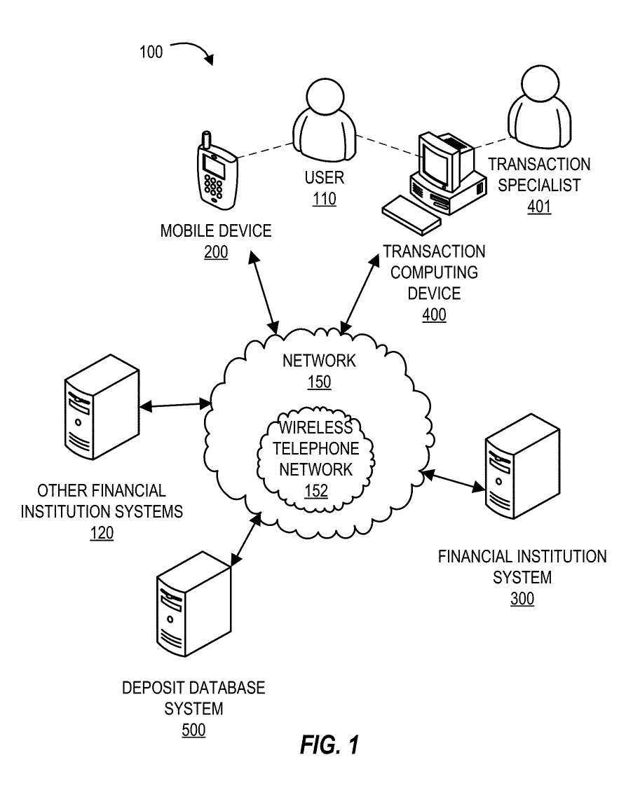

FIG. 1 provides a block diagram illustrating a system and environment 100, in accordance with an embodiment of the invention. As illustrated in FIG. 1, the environment 100 includes a user 110, where the user 110 represents a customer of one or more financial institutions. A user of the system may be a person, but may also be a business (e.g., a merchant) or any other entity. As used herein, the term “user” shall generally mean a person or entity that is requesting a deposit with a financial institution.

The environment 100 also may include a mobile device 200 and a personal computing device transaction computing device 400 for use by the first user 110 and/or a transaction specialist 401. In some embodiments, a mobile device 200 may be associated with a different person or entity than the user 110. For example, the system 100 may establish an electronic communication channel with person or entity for whom the user 110 is conducting a deposit transaction, such that the system may request additional information from this other person or entity. The transaction computing device 400 may be any device that employs a processor and memory and can perform computing functions, such as a personal computer, a mobile device, an automated teller machine (ATM), a point of transaction (POT) device, and the like. As used herein, a “mobile device” 200 is any mobile communication device, such as a cellular telecommunications device (i.e., a cell phone or mobile phone), personal digital assistant (PDA), a mobile Internet accessing device, or other mobile device.

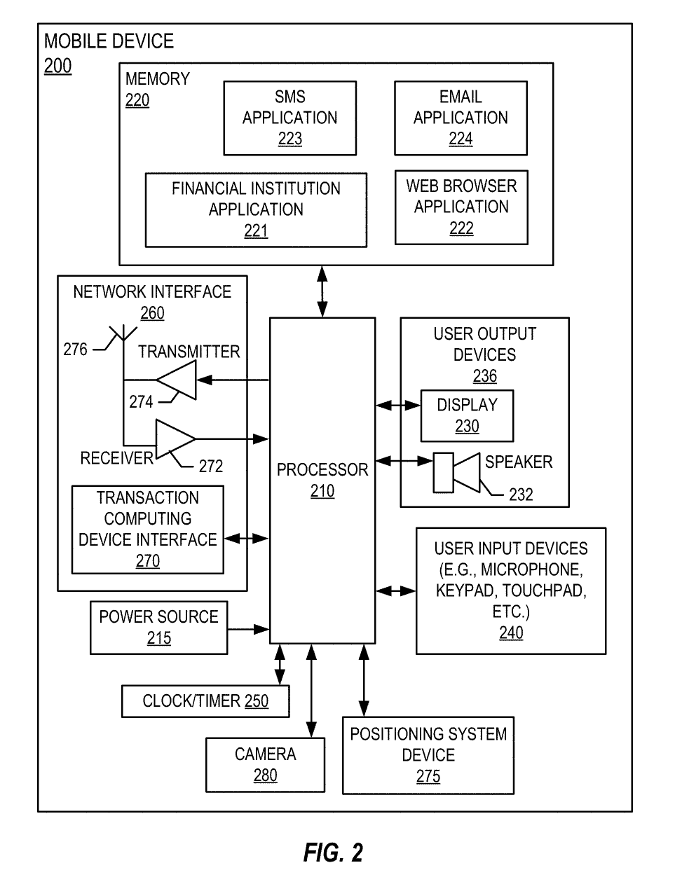

The mobile device 200 and the transaction computing device 400 are configured to communicate over a network 150 with a financial institution system 300 and, in some cases, one or more other financial institution systems 120 and with a deposit database system 500. The mobile device 200, the transaction computing device 400, the deposit database system 500, and any other participating financial institution systems 120 are each described in greater detail below with reference to FIGS. 2-5. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In one embodiment, the network 150 includes a wireless telephone network 152.

In general, a mobile device 200 is configured to connect with the network 150 to interface the user 110 or a different person with an application of the financial institution system 300 and/or the transaction computing device 400. A user 110, in order to access the user's account(s), online banking application and/or mobile banking application on the financial institution system 300 must authenticate with the financial institution system 300 and/or another system. For example, logging into the financial institution system 300 generally requires that the user 110 authenticate his/her identity using a user name, a passcode, a cookie, a biometric identifier, a private key, a token, and/or another authentication mechanism that is provided by the first user 110 to the financial institution system 300 via the mobile device 200.

The financial institution system 300 is in network communication with other devices, such as other financial institutions' transaction/banking systems 120, deposit database systems 500, and a transaction computing device 400 that is configured to communicate with the network 150 to process requests for deposits and take actions regarding deposits and regulatory agency requirements. In one embodiment, the invention may provide an application download server such that software applications that support the financial institution system 300 can be downloaded to the mobile device 200 and/or the transaction computing device 400.

In some embodiments of the invention, the application download server is configured to be controlled and managed by one or more third-party data providers (not shown in FIG. 1) over the network 150. In other embodiments, the application download server is configured to be controlled and managed over the network 150 by the same entity or entities that maintains the financial institution system 300.

In some embodiments of the invention, the deposit database systems 500 are configured to be controlled and managed by one or more third-party data providers (not shown), financial institutions or other entities over the network 150. In other embodiments, the deposit database systems 500 are configured to be controlled and managed over the network 150 by the same entity that maintains the financial institution system 300.

FIG. 2 provides a block diagram illustrating a user's mobile device 200 of FIG. 1 in more detail, in accordance with embodiments of the invention. In one embodiment of the invention, the mobile device 200 is a mobile telephone. However, it should be understood that a mobile telephone is merely illustrative of one type of mobile device 200 that may benefit from, employ, or otherwise be involved with embodiments of the present invention and, therefore, should not be taken to limit the scope of embodiments of the present invention. Other types of mobile devices 200 may include portable digital assistants (PDAs), pagers, mobile televisions, gaming devices, laptop computers, cameras, video recorders, audio/video player, radio, GPS devices, or any combination of the aforementioned.

Some embodiments of the mobile device 200 include a processor 210 communicably coupled to such devices as a memory 220, user output devices 236, user input devices 240, a network interface 260, a power source 215, a clock or other timer 250, a camera 280, and a positioning system device 275. The processor 210, and other processors described herein, generally include circuitry for implementing communication and/or logic functions of the mobile device 200. For example, the processor 210 may include a digital signal processor device, a microprocessor device, and various analog to digital converters, digital to analog converters, and/or other support circuits. Control and signal processing functions of the mobile device 200 are allocated between these devices according to their respective capabilities. The processor 210 thus may also include the functionality to encode and interleave messages and data prior to modulation and transmission. The processor 210 can additionally include an internal data modem. Further, the processor 210 may include functionality to operate one or more software programs, which may be stored in the memory 220. For example, the processor 210 may be capable of operating a connectivity program, such as a web browser application 222. The web browser application 222 may then allow the mobile device 200 to transmit and receive web content, such as, for example, location-based content and/or other web page content, according to a Wireless Application Protocol (WAP), Hypertext Transfer Protocol (HTTP), and/or the like.

The processor 210 is configured to use the network interface 260 to communicate with one or more other devices on the network 150. In this regard, the network interface 260 includes an antenna 276 operatively coupled to a transmitter 274 and a receiver 272 (together a “transceiver”). The processor 210 is configured to provide signals to and receive signals from the transmitter 274 and receiver 272, respectively. The signals may include signaling information in accordance with the air interface standard of the applicable cellular system of the wireless telephone network 152. In this regard, the mobile device 200 may be configured to operate with one or more air interface standards, communication protocols, modulation types, and access types. By way of illustration, the mobile device 200 may be configured to operate in accordance with any of a number of first, second, third, and/or fourth-generation communication protocols and/or the like. For example, the mobile device 200 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 3GPP protocols and/or the like. The mobile device 200 may also be configured to operate in accordance with non-cellular communication mechanisms, such as via a wireless local area network (WLAN) or other communication/data networks.

The network interface 260 may also include a transaction computing device interface 270. The transaction computing device interface 270 may include software, such as encryption software, and hardware, such as a modem, for communicating information to and/or from one or more devices on a network 150 and connected with or that are part of the financial institution systems 300. For example, the mobile device 200 may be configured so that it can be used as an interface for interacting transaction computing device 400 for inputting information about one or more transactions. For example, the mobile device 200 may wirelessly communicate encrypted activity information to a terminal of the network 150 or transaction computing device 400.

As described above, the mobile device 200 has a user interface that is, like other user interfaces described herein, made up of user output devices 236 and/or user input devices 240. The user output devices 236 include a display 230 (e.g., a liquid crystal display or the like) and a speaker 232 or other audio device, which are operatively coupled to the processor 210. The user input devices 240, which allow the mobile device 200 to receive data from a user such as the user 110, may include any of a number of devices allowing the mobile device 200 to receive data from the user 110, such as a keypad, keyboard, touch-screen, touchpad, microphone, mouse, joystick, other pointer device, button, soft key, and/or other input device(s). The user interface may also include a camera 280, such as a digital camera.

The mobile device 200 may also include a positioning system device 275 that is configured to be used by a positioning system to determine a location of the mobile device 200. For example, the positioning system device 275 may include a GPS transceiver. In some embodiments, the positioning system device 275 is at least partially made up of the antenna 276, transmitter 274, and receiver 272 described above. For example, in one embodiment, triangulation of cellular signals may be used to identify the approximate location of the mobile device 200. In other embodiments, the positioning system device 275 includes a proximity sensor or transmitter, such as an RFID tag, that can sense or be sensed by devices known to be located proximate a merchant or other location to determine that the mobile device 200 is located proximate these known devices.

The mobile device 200 further includes a power source 215, such as a battery, for powering various circuits and other devices that are used to operate the mobile device 200. Embodiments of the mobile device 200 may also include a clock or other timer 250 configured to determine and, in some cases, communicate actual or relative time to the processor 210 or one or more other devices.

The mobile device 200 also includes a memory 220 operatively coupled to the processor 210. As used herein, memory includes any computer readable medium (as defined herein below) configured to store data, code, or other information. The memory 220 may include volatile memory, such as volatile Random Access Memory (RAM) including a cache area for the temporary storage of data. The memory 220 may also include non-volatile memory, which can be embedded and/or may be removable. The non-volatile memory can additionally or alternatively include an electrically erasable programmable read-only memory (EEPROM), flash memory or the like.

The memory 220 can store any of a number of applications which comprise computer-executable instructions/code executed by the processor 210 to implement the functions of the mobile device 200 and/or one or more of the process/method steps described herein. For example, the memory 220 may include such applications as a conventional web browser application 222 and/or a financial institution application 221. These applications also typically provide a graphical user interface (GUI) on the display 230 that allows the first user 110 to communicate with the mobile device 200, the financial institution system 300, and/or other devices or systems. In one embodiment of the invention, when the user 110 decides to enroll in a financial institution application 221 program, the user 110 downloads, is assigned, or otherwise obtains the financial institution application 221 from the financial institution system 300, or from a distinct application server. In other embodiments of the invention, the user 110 interacts with the financial institution system 300 or transaction computing device via the web browser application 222 in addition to, or instead of, the financial institution application 221.

The memory 220 can also store any of a number of pieces of information, and data, used by the mobile device 200 and the applications and devices that make up the mobile device 200 or are in communication with the mobile device 200 to implement the functions of the mobile device 200 and/or the other systems described herein. For example, the memory 220 may include such data as user authentication information, and the like.

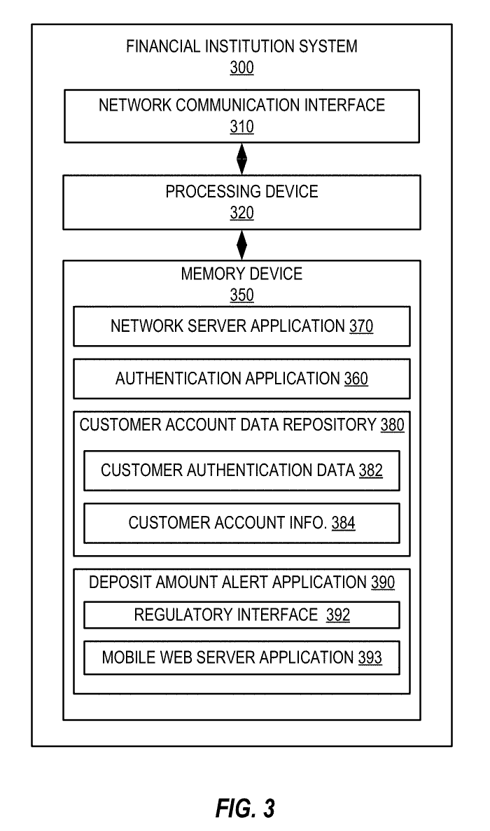

FIG. 3 provides a block diagram illustrating the financial institution system 300, in greater detail, in accordance with embodiments of the invention. As illustrated in FIG. 3, in one embodiment of the invention, the financial institution system 300 includes one or more processing devices 320 operatively coupled to a network communication interface 310 and a memory device 350. In certain embodiments, the financial institution system 300 is operated by a first entity, such as a financial institution, while in other embodiments, the financial institution system 300 is operated by an entity other than a financial institution.

It should be understood that the memory device 350 may include one or more databases or other data structures/repositories. The memory device 350 also includes computer-executable program code that instructs the processing device 320 to operate the network communication interface 310 to perform certain communication functions of the financial institution system 300 described herein. For example, in one embodiment of the financial institution system 300, the memory device 350 includes, but is not limited to, a network server application 370, an authentication application 360, a customer account data repository 380 which includes customer authentication data 382 and customer account information 384, a deposit amount alert application 390 which includes a regulatory interface 492, a mobile web server application 393, and other computer-executable instructions or other data. The computer-executable program code of the network server application 370, the authentication application 360, or the deposit amount alert application 390 may instruct the processing device 320 to perform certain logic, data-processing, and data-storing functions of the financial institution system 300 described herein, as well as communication functions of the financial institution system 300.

In one embodiment, the customer account data repository 380 includes customer authentication data 382 and customer account information 384. The network server application 370, the authentication application 360, and the deposit amount alert application 390 are configured to invoke or use the customer account information 384, the customer authentication data 382, and the regulatory interface 492 when authenticating a user to the financial institution system 300 and/or the transaction computing device 400.

As used herein, a “communication interface” generally includes a modem, server, transceiver, and/or other device for communicating with other devices on a network, and/or a user interface for communicating with one or more customers. Referring again to FIG. 3, the network communication interface 310 is a communication interface having one or more communication devices configured to communicate with one or more other devices on the network 350, such as the mobile device 200, the transaction computing device 400, the other financial institution banking systems 120, and the deposit database system 500. The processing device 320 is configured to use the network communication interface 310 to transmit and/or receive data and/or commands to and/or from the other devices connected to the network 150.

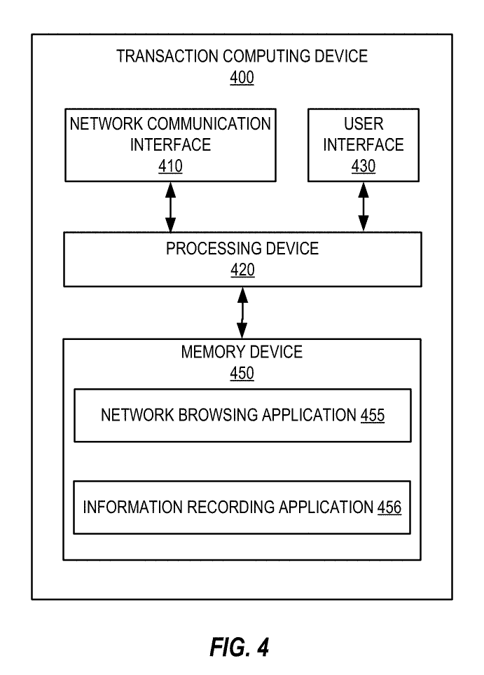

Referring now to FIG. 4, the transaction computing device 400 associated with the transaction specialist 401 also includes various features, such as a network communication interface 410, a processing device 420, a user interface 430, and a memory device 450. The network communication interface 410 includes a device that allows the transaction computing device 400 to communicate over the network 150 (shown in FIG. 1). In one embodiment of the invention, a network browsing application 455 provides for a user to establish network communication with a financial institution system 300 and/or a mobile device such as the mobile device 200 (shown in FIG. 1) for the purpose of requesting information associated with reporting a form to a regulatory agency, in accordance with embodiments of the invention. Additionally, an information recording application 456 may record information regarding a deposit request and/or information associated with reporting a form to a regulatory agency.

As used herein, a “processing device,” such as the processing device 420, generally refers to a device or combination of devices having circuitry used for implementing the communication and/or logic functions of a particular system. For example, a processing device 420 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 420 may further include functionality to operate one or more software programs based on computer-executable program code thereof, which may be stored in a memory. As the phrase is used herein, a processing device 420 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” 430 generally includes a plurality of interface devices and/or software that allow a customer (e.g., the user 110) to input commands and data to direct the processing device to execute instructions. For example, the user interface 430 presented in FIG. 4 may include a graphical user interface (GUI) or an interface to input computer-executable instructions that direct the processing device 420 to carry out specific functions. The user interface 430 employs certain input and output devices to input data received from the user 110 or transaction specialist 401 or output data to the user 110, a different person associated with a deposit request, or the transaction specialist 401. These input and output devices may include a display, mouse, keyboard, button, touchpad, touch screen, microphone, speaker, LED, light, joystick, switch, buzzer, bell, and/or other customer input/output device for communicating with one or more customers.

As used herein, a “memory device” 450 generally refers to a device or combination of devices that store one or more forms of computer-readable media for storing data and/or computer-executable program code/instructions. Computer-readable media is defined in greater detail below. For example, in one embodiment, the memory device 450 includes any computer memory that provides an actual or virtual space to temporarily or permanently store data and/or commands provided to the processing device 420 when it carries out its functions described herein.

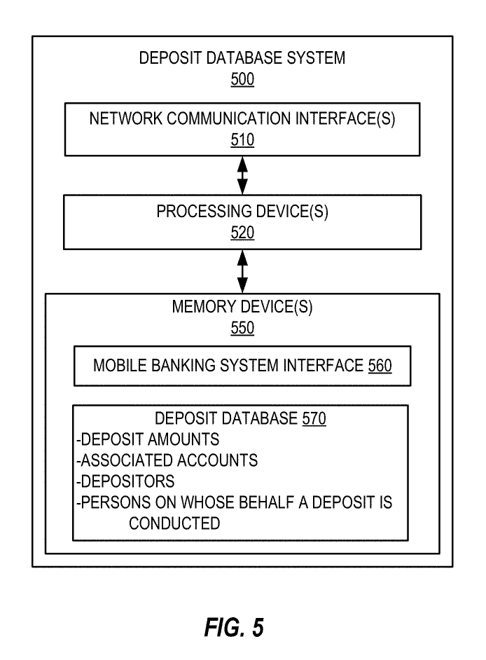

FIG. 5 provides a block diagram illustrating a deposit database system 500, in accordance with embodiments of the invention. As illustrated in FIG. 5, the deposit database system 500 generally includes, but is not limited to, a network communication interface 510, one or more processing devices 520, and one or more memory devices 550. The processing device 520 is operatively coupled to the network communication interface 510 and the memory device 550. In one embodiment of the deposit database system 500, the memory device 550 stores, but is not limited to, a mobile banking system interface 560 and deposit database 570. In some embodiments, the deposit database 570 stores data including, but not limited to, deposit amounts, associated accounts for each deposit, depositors (i.e., an individual or organization that deposits the funds), persons on whose behalf a deposit is conducted, deposit accounts, accounts associates with the transferred funds, validation information, authentication information, and the like. In one embodiment of the invention, both the mobile banking system interface 560 and the deposit database 570 may associate with applications having computer-executable program code that instructs the processing device 520 to operate the network communication interface 510 to perform certain communication functions involving the deposit database 570 described herein. In one embodiment, the computer-executable program code of an application associated with the deposit database 570 may also instruct the processing device 520 to perform certain logic, data processing, and data storing functions of the application associated with the deposit database 570 described herein.

The network communication interface 510 is a communication interface having one or more communication devices configured to communicate with one or more other devices on the network 150. The processing device 520 is configured to use the network communication interface 510 to receive information from and/or provide information and commands to a mobile device 200, a transaction computing device 400, other financial institution systems 120, the financial institution system 300 and/or other devices via the network 150. In some embodiments, the processing device 520 also uses the network communication interface 510 to access other devices on the network 150, such as one or more web servers of one or more third-party data providers. In some embodiments, one or more of the devices described herein may be operated by a second entity so that the second entity controls the various functions involving the deposit database system 500. For example, in one embodiment of the invention, although the financial institution system 300 is operated by a first entity (e.g., a financial institution), a second entity operates the deposit database system 500 that stores received data in the deposit database 570.

As described above, the processing device 520 is configured to use the network communication interface 510 to gather data, such as data corresponding deposits to the deposit database 570 from various data sources such as the transaction computing device and other deposit database systems 500. The processing device 520 stores the data that it receives in the deposit database 570 stored in the memory device 550.

As discussed above, in some embodiments of the invention, an application server or application download server (not shown) might be provided. The application download server may include a network communication interface, a processing device, and a memory device. The network communication interface and processing device are similar to the previously described network communication interface 310 and the processing device 320 previously described. For example, the processing device is operatively coupled to the network communication interface and the memory device. In one embodiment of the application download server, the memory device includes a network browsing application having computer-executable program code that instructs the processing device to operate the network communication interface to perform certain communication functions of the application download server described herein. In some embodiments of the invention, the application download server provides applications that are to be downloaded to a qualified user's mobile device or personal computing device.

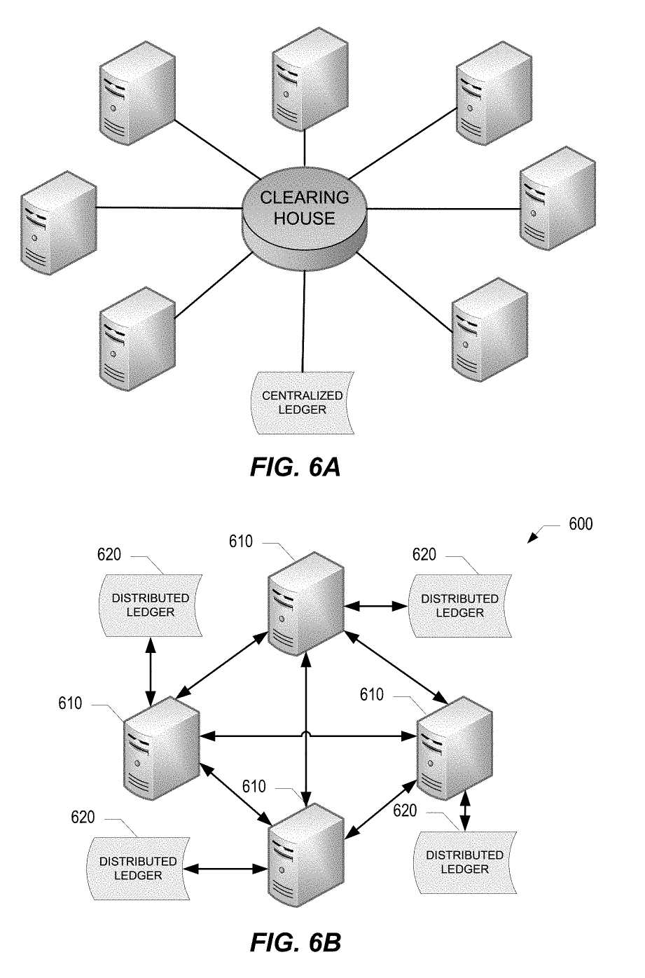

Rather than utilizing a centralized database of transaction information as discussed with reference to some embodiments above and as shown in FIG. 6A, other various embodiments of the invention may use a decentralized block chain configuration or architecture as shown in FIG. 6B in order to track, monitor, and/or store deposit information in a block chain network. Such a decentralized block chain configuration ensures accurate mapping of transaction data to financial institutions, merchants, third parties, and/or customers. Accordingly, a block chain configuration may be used to maintain an accurate ledger of transaction data, security levels of entities associated with the block chain configuration and to provide validation of transaction data and security levels involving the entities associated with the block chain network. For example, a single financial institution may manage a block chain network across multiple physical locations, with multiple employees or contractors of the financial institution having varied levels of access to accessing, writing, editing, and/or reading the stored deposit data. Furthermore, in some embodiments, multiple different financial institutions may have be associated with a single distributed block chain network, such that a wider collection of deposit data may be received, monitored, and analyzed by the system. As such, the deposit database system 500 may include one or more block chain networks.

A block chain or blockchain is a distributed database that maintains a list of data records, the security of which is enhanced by the distributed nature of the block chain. A block chain typically includes several nodes, which may be one or more systems, machines, computers, databases, data stores or the like operably connected with one another. In some cases, each of the nodes or multiple nodes are maintained by different entities. A block chain typically works without a central repository or single administrator. One well-known application of a block chain is the public ledger of transactions for cryptocurrencies such as used in bitcoin. The data records recorded in the block chain are enforced cryptographically and stored on the nodes of the block chain.

A block chain provides numerous advantages over traditional databases. A large number of nodes of a block chain may reach a consensus regarding the validity of a transaction contained on the transaction ledger. Similarly, when multiple versions of a document or transaction exits on the ledger, multiple nodes can converge on the most up-to-date version of the transaction. For example, in the case of a virtual currency transaction, any node within the block chain that creates a transaction can determine within a level of certainty whether the transaction can take place and become final by confirming that no conflicting transactions (i.e., the same currency unit has not already been spent) confirmed by the block chain elsewhere.

The block chain typically has two primary types of records. The first type is the transaction type, which consists of the actual data stored in the block chain. The second type is the block type, which are records that confirm when and in what sequence certain transactions became recorded as part of the block chain. Transactions are created by participants using the block chain in its normal course of business, (e.g., when someone sends cryptocurrency to another person), and blocks are created by users known as “miners” who use specialized software/equipment to create blocks. Users of the block chain create transactions that are passed around to various nodes of the block chain. A “valid” transaction is one that can be validated based on a set of rules that are defined by the particular system implementing the block chain. For example, in the case of cryptocurrencies, a valid transaction is one that is digitally signed, spent from a valid digital wallet and, in some cases, meets other criteria. In some block chain systems, miners are incentivized to create blocks by a rewards structure that offers a pre-defined per-block reward and/or payments offered within the transactions validated themselves. Thus, when a miner successfully validates a transaction on the block chain, the miner may receive rewards and/or payments as an incentive to continue creating new blocks.

As mentioned above and referring to FIG. 6B, a block chain 600 is typically decentralized—meaning that a distributed ledger 620 (i.e., a decentralized ledger) is maintained on multiple nodes 610 of the block chain 600. One node in the block chain may have a complete or partial copy of the entire ledger or set of transactions and/or blocks on the block chain. Transactions are initiated at a node of a block chain and communicated to the various nodes of the block chain. Any of the nodes can validate a transaction, add the transaction to its copy of the block chain, and/or broadcast the transaction, its validation (in the form of a block) and/or other data to other nodes. This other data may include time-stamping, such as is used in cryptocurrency block chains.

Various other specific-purpose implementations of block chains have been developed. These include distributed domain name management, decentralized crowd-funding, synchronous/asynchronous communication, decentralized real-time ride sharing and even a general purpose deployment of decentralized applications.

Block chain networks may be private, in that they are accessible only by selected, authorized personnel, and/or a single entity such as a financial institution. In some embodiments, a block chain network may be public, such that any person or entity may be allowed to access the block chain. Additionally, Hybrid block chain environments may be used. A hybrid block chain network environment may comprise a certain portion of the block chain nodes being owned by known, authorized, and validated personnel, while another portion of the same block chain is accessible by any member of the public. In such embodiments, the private nodes may require user authorization before a person is allowed to access, read, write, or edit information associated with that node and/or the distributed ledger.

In other hybrid embodiments, multiple block chain networks are provided, being private and/or public, where each block chain network is distinct from other block chain networks. These multiple block chain networks may interact through a distributed ledger, or each block chain may serve as a node in a combined block chain network. In such embodiments, multiple different entities (e.g., financial institutions) may have full control over data associated with their own clients and/or systems, but each entity may have access to at least a portion of every other entity's data records. Therefore, entities may be able to share certain information with other entities, while still maintaining full control over their customer and system information.

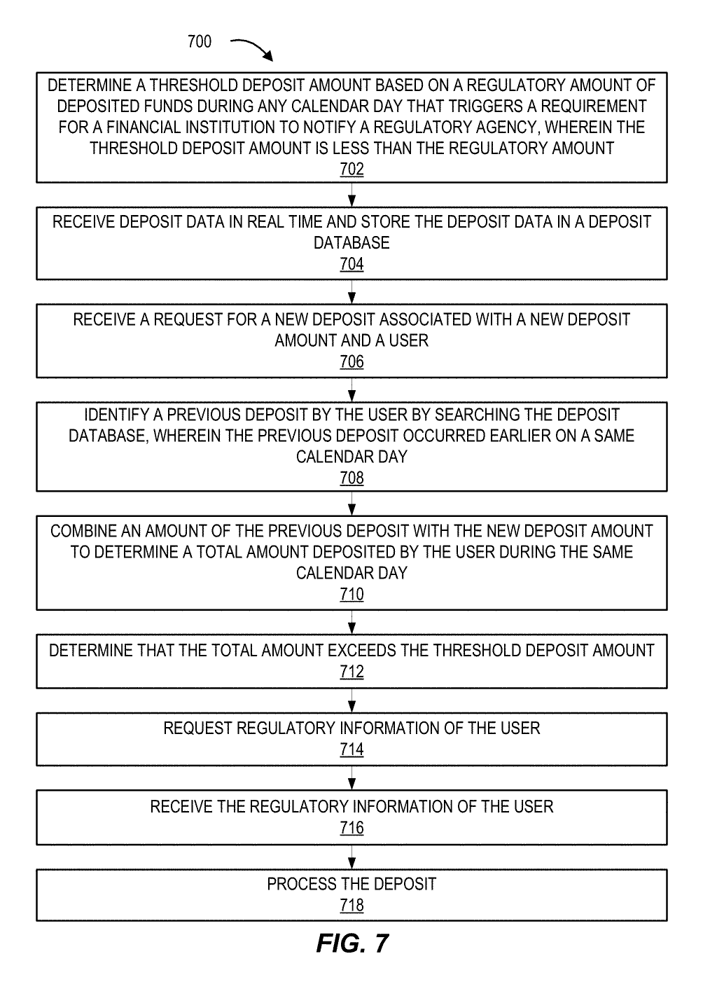

Referring now to FIG. 7, a flowchart is provided to illustrate one embodiment of a process 700 for triggering alerts associated with deposit amounts, in accordance with embodiments of the invention. In some embodiments, the process 700 may include block 702, where the system determines a threshold deposit amount based on a regulatory amount of deposited funds during any calendar day that triggers a requirement for a financial institution to notify a regulatory agency, wherein the threshold deposit amount is less than the regulatory amount.

A regulatory agency may have a limit (e.g., the regulatory amount) for the amount of funds that may be deposited in a certain period of time (i) by a single person (e.g., the user), (ii) into a single account, (iii) into an account on behalf of a single person, and/or (iv) on behalf of a single company. For example, the regulatory agency may have a limit for the amount of funds that can be deposited within a single day. This limit can be a regulatory amount that, if exceeded, requires a financial institution associated with one or more of the transactions to file a report to the regulatory agency providing information and details about the transfer that exceeds the regulatory amount.

While it is easy for a financial institution to determine whether a single deposit exceeds this regulatory amount, it can be difficult for the financial institution to track multiple deposits made by a single user, for a single account, on behalf of a single person, or on behalf of a single company within a certain period of time. The tracking is difficult because the financial institution will have to parse through transaction records for the period of time, for multiple transaction locations, and look for information that points to an accumulation of deposits essentially made by the same person and/or organization that exceeds the regulatory amount.

Therefore, the system may institute a financial institution-side triggering threshold deposit amount to determine whether a currently pending or recently conducted transaction likely is or will contribute to an accumulated total amount of deposited funds that will exceed the regulatory amount. In some embodiments, the system may receive input from a regulatory expert of the financial institution that sets the triggering threshold deposit amount for the system to use. For example, a regulatory specialist may determine that any deposit or accumulation of deposits over a certain amount of funds likely will be contributing to an overall accumulation during the regulatory time period that exceeds the regulatory amount.

In some embodiments, the system determines the threshold deposit amount based on a percentage of or a predetermined amount less than the regulatory amount of deposited funds during any calendar day that triggers a requirement for a financial institution to notify a regulatory agency. This percentage may also be provided by the regulatory specialist. For example, the system may receive an indication that the threshold deposit amount should be X % less than a regulatory amount. The system may then determine the regulatory amount (e.g., the system may receive the regulatory amount from the regulatory agency, or the system may search a database or web browser to determine the regulatory amount). Next, the system may establish the threshold deposit amount as X % less than the determined regulatory amount. Similarly, the regulatory amount could be determined as a specified amount of funds (e.g., as specified by the regulatory specialist) less than the identified regulatory amount.

Alternatively, in some embodiments, the system determines the threshold deposit amount based on a deposit trend that indicates that the threshold deposit amount would be exceeded if the deposit trend continues. For example, the system may search a database of deposit data for the regulatory time period for related deposits (e.g., deposits made by the same user, made on a specific person's behalf, made to a certain account, made for a certain organization, and the like) to determine a trend of deposits. The system may extract the time and amounts of each deposit, and extrapolate a trend based on the extracted deposit information. The system can use this trend to determine an expected deposit amount for the end of the regulatory time period. This expected deposit amount can be compared to the regulatory amount to determine that the current deposit likely will contribute to the regulatory amount being exceeded.

In general, the system is setting a threshold deposit amount that is less than the regulatory amount so that the system can identify a set of transactions that likely will eventually exceed the regulatory amount during the regulatory time period. By detecting this likelihood of exceeding the regulatory amount, the system can alert the financial institution to begin preparing the report, so that the financial institution can file an accurate report in a timely manner. This system can make the threshold determination while the depositing user is still conducting a current deposit, so the financial institution can request information from the user as the current deposit is made, in anticipation for needing this information for a likely report.

In some embodiments, the process 700 includes step 704, where the system receives deposit data in real time and store the deposit data in a deposit database. The system may receive deposit data for all financial institution branches, automated teller machines (ATMs), point of transaction (POT) devices, mobile transactions, and other locations and methods of conducting transactions and/or conducting deposits. The system may receive this deposit data in real time (e.g., immediately), or substantially real time (e.g., within a few seconds), as each piece of deposit data is determined or created in a transaction associated with the financial institution. As the deposit data is received by the system, the system may automatically store the deposit data in a deposit database. This deposit database may be easily accessible and readable by the system, such that deposit data may be compared, analyzed, and otherwise examined by the system in real time, or substantially in real time.

In some embodiments, the system receives deposit data in real time from a single financial institution that is associated with the system. In other embodiments, the system receives deposit data from a plurality of financial institutions that may or may not be related. For example, each of the plurality of financial institutions may receive and monitor their own deposit data, and store their at least a portion of the deposit data in a centralized regulatory database, where the data is accumulated with data from other financial institutions or other third parties. In some embodiments, each financial institution may set a threshold amount for which the financial institution will report deposit data associated with a customer's deposit into the collective database for review and analysis by other financial institutions and/or associated third parties. This way, smaller deposits may be ignored by the community of financial institutions because it is unlikely that a small deposit will be part of an accumulated total that exceeds a regulatory reporting amount.

Additionally, in some embodiments, the process 700 includes block 706, where the system receives a request for a new deposit associated with a new deposit amount and a user. As used here, the user represents an individual or organization that is actually entering the deposit transaction. The user may also be associated with an account to which the deposited funds are transferred. In some embodiments, the user is not directly associated with the account and/or an organization or person on whose behalf the deposit is being made. Instead, the user is merely acting as a representative for the organization or person on whose behalf the deposit is being made. For example, the user may be depositing an amount of funds for a company, of which the user is an authorize employee or otherwise serves in a representative capacity.

The request may include an amount being requested, the user's name and/or other identification information, a name for a person on whose behalf the deposit is being made, one or more accounts from which the deposit is being transferred from, one or more accounts from which the deposit is being made, and the like.

This deposit request, and the deposit request information may automatically be transmitted to the system by a transaction computing device, a mobile device, or any other computing device associated with the transaction request. For example, if the user is depositing funds at an ATM, the ATM may request the deposit request information at an interactive user interface of the ATM, receive the deposit request information from the user, and automatically transmit the deposit request information from the user to the rest of the system for analysis before the ATM is authorized by the system to process the deposit requested.

The process 700 may also include block 708, where the system identifies a previous deposit by the user by searching the deposit database, wherein the previous deposit occurred earlier on a same calendar day. Once the system has received the deposit request, the system can compare the received deposit request information with the deposit data stored in the deposit database to determine if the deposit request information matches any of the stored deposit data within the regulatory time period. For example, if the regulatory time period is one calendar day, then the system will compare the received deposit request information with the stored deposit data that has was conducted within the past calendar day, and will not compare the received requested deposit data against older deposit data. The system can also compare the received requested deposit data against other pending requested deposit data. For example, the system could determine that two different deposit transactions are being simultaneously (or substantially simultaneously) requested. The system is then able to compare these two pending deposit transaction requests, and may arbitrarily declare one of the pending deposit transaction requests to have occurred “earlier” on the same calendar day for purposes of this process 700. Because the system receives the transaction data in real time, the system is able to confidently determine whether previous deposits have occurred in relatively short time frames, or simultaneously.

While this process 700 refers to a single “previous deposit,” it should be noted that any number of previous deposits can be identified by the system and each previous deposit may be considered a unique previous deposit and/or a cumulative single “previous deposit.” Additionally, while this process 700 refers to deposits conducted by the same user, it should be noted that the system may also and/or alternatively identify previous deposits that were made by representatives of a same company, made to a single account or related accounts, and/or made on the behalf of a specific person (e.g., a “first person”). This process 700 describes steps for analyzing the current deposit with previous deposits made by the same user, but any of the aforementioned types of prior deposits may be used in place of “deposits made by the same user.”

In some embodiments, the process 700 includes block 710, where the system combines an amount of the previous deposit with the new deposit amount to determine a total amount deposited by the user during the same calendar day. In embodiments where multiple previous deposits are identified by the system, the system may combine all previous deposits to determine the total amount deposited by the user during the same calendar day.

In embodiments where the threshold deposit amount is really a trend determined by the system (as referenced in the discussion of block 702), the system may compare the time and amounts of each previous deposit and the currently pending deposit request to determine the trend and the expected final, accumulated deposit amount for the end of the regulatory time period. This estimated, expected, accumulated final deposit amount can be substituted for the “total amount deposited,” as referenced in this process 700.

Additionally, in some embodiments, the process 700 includes block 712, where the system determines that the total amount exceeds the threshold deposit amount. As mentioned above, the threshold deposit amount is less than the regulatory amount (i.e., the regulatory limit), so the total amount may not necessarily have already triggered the regulatory amount. However, the fact that the total amount exceeds the threshold deposit amount can be a strong indicator that one or more subsequent deposits could be made to grow the total amount deposited to an amount that exceeds the regulatory amount. Therefore, in response to determining that the threshold deposit amount has been exceeded, the system may determine that the financial institution should begin collecting information that the financial institution does not currently possess, but that will be required or desired by the report for the reporting agency. In this manner, the system's determination that the total amount of deposited funds exceeds the threshold deposit amount can act as a trigger for the financial institution to begin collecting information.

Therefore, in response to determining that the total amount exceeds the threshold deposit amount, the process 700 may include block 714, where the system requests identification information of the user. In some embodiments, the system alerts a transaction specialist of the need for additional and/or missing information that the financial institution will need in a report to the regulatory agency, should a subsequent deposit grow the total amount of deposited funds to exceed the regulatory amount. The transaction specialist may provide one or more forms to the user, then enter the provided information into a transaction computing device and transmit the additional information to the system. Additionally, the transaction specialist may ask the user for the additional information, and enter the additional information into a user interface of the transaction computing device.

In some embodiments, the system may command a user interface of the transaction computing device to display an electronic form with editable data fields for which the user may input the requested additional regulatory and/or identification information. The regulatory information may be any information required for completing or improving the usefulness of a regulatory agency's reporting form.

In some embodiments, the user may not know one or more pieces of requested information. In such cases, the system may establish an electronic communication with a mobile computing device of a person on whose behalf the transaction is being conducted. The system may then command a user interface of this mobile computing device to display editable data fields that the person on whose behalf the transaction is being conducted may edit to provide the requested information.

Furthermore, the process 700 may include block 716, where the system receives the regulatory information of the user. As described above, the system may receive this information from a transaction computing device, a mobile device, an ATM, or any other device with input capabilities. The system may store this additional information in a database, such as a reporting database, for future use. The system may store the data for a predetermined time that is at least as long as current regulatory time period. For example, if the regulatory time period is one day calendar, then the system may maintain the received regulatory information at least until 12:01 AM on the next calendar day. Of course, the system may maintain the received regulatory information for a longer period of time (e.g., one week, one month, one year, or the like, past the end time of the regulatory time period).

In some embodiments, the system may store a copy of the data associated with the previous deposit(s), the data associated with the new deposit request, and the received identification and/or regulatory information from the user in a separate database from the deposit database. In this manner, the system can compare new incoming deposit request data to a database comprising substantially less data than the large deposit database. This allows the system for reach determinations as to whether an accumulated amount of deposited funds for a user, a person on home transactions are conducted, an organization, or the like, exceeds the regulatory amount within the regulatory time limit faster than if the system has to re-search the entire deposit database for each new received deposit transaction request.

Finally, the process 700 may continue to block 718, where the system processes the deposit. Once the system has determined that the financial institution now has the requested regulatory information, the system may determine that the financial institution is prepared to timely and efficiently file a report to the regulatory agency, if required. Therefore, the system can allow the deposit transaction to be conducted. In some embodiments, the system sends a command to a transaction computing device to authorize the deposit transaction.

In some embodiments, the system may also determine that the total amount deposited by the user during the same calendar day exceeds the regulatory amount, and therefore automatically transmit a report comprising the regulatory information of the user to the regulatory agency.

Because the system is detecting when the user is depositing a relatively large amount of funds, the system may be able to automatically provide offers to the user based on the new deposit request and/or the total amount deposited. In this manner, the financial institution may wish to provide an offer to the user for opening or upgrading one or more financial accounts held by the financial institution, such that the user may deposit the funds in one or more of these financial accounts. For example, the system may wish to provide an offer the user for transferring the funds associated with the deposit request into an investment and/or savings account that will allow the user to grow the funds over time with interest.

Therefore, the system may transmit a command to a user interface of a computing device at a location of the request for the new deposit, causing the user interface to display a selectable offer to open an investment account to which the deposit amount may be transferred, receive an indication from the user interface that the user selected the offer, and then transmit the deposit amount to the investment account.

As discussed above, the system may also track deposit data based on the identities of persons on whose behalf each deposit is made. This will help the financial institution and the system keep track of such persons, as the regulatory agency may require reporting based on funds that are deposited or transferred on behalf of specific persons. Therefore, in some embodiments, the system may identify a first person on whose behalf the new deposit is being conducted. The system may then identify a previous deposit (or multiple previous deposits) for the first person by searching the deposit database, wherein the previous deposit occurred earlier on a same calendar day. Additionally, the system may combine an amount of the previous deposit (or a combined amount of all previous deposits) with the new deposit amount to determine a total amount deposited for the first person during the same calendar day. Furthermore, the system may determine that the total amount deposited for the first person exceeds the threshold deposit amount. In response to determining that the total amount deposited exceeds the threshold deposit amount, the system may request regulatory information from the first person (e.g., via a mobile communication device, and the like). Once the system receives the regulatory information from the first person, then the system can process the deposit.

Additionally, and as discussed above, the system may also track deposit data based on accounts to or from which a deposit is transacted. This will help the financial institution and the system keep track of such accounts, as the regulatory agency may require reporting based on the funds that are deposited into or transferred from a specific account. Therefore, in some embodiments, the system may identify a first account to which the new deposit is being conducted. This example describes an account to which a deposit is being conducted, but it should be noted that this first account could also be an account from which funds are being transferred as part of the deposit transaction. Next, the system may identify a previous deposit for the first account by searching the deposit database, wherein the previous deposit occurred earlier on a same calendar day. Additionally, the system may combine an amount of the previous deposit with the new deposit amount to determine a total amount deposited for the first account during the same calendar day. Furthermore, the system may determine that the total amount deposited for the first account exceeds the threshold deposit amount. In response to determining that the total amount deposited for the first account exceeds the threshold deposit amount, the system may request regulatory information from the user, or another person associated with the first account. Once this additional information (i.e., information necessary or helpful to filling out the regulatory report) is received, the system may process the deposit.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for triggering alerts associated with deposit amounts, the system comprising:
a memory device; and
one or more processing devices operatively coupled to the memory device, wherein the one or more processing devices are configured to execute computer-readable program code to:
determine a threshold deposit amount based on a regulatory amount of deposited funds during any calendar day that triggers a requirement for a financial institution to notify a regulatory agency, wherein the threshold deposit amount is less than the regulatory amount;
receive deposit data in real time and store the deposit data in a deposit database;
receive a request for a new deposit associated with a new deposit amount and a user;
identify a previous deposit by the user by searching the deposit database, wherein the previous deposit occurred earlier on a same calendar day;
combine an amount of the previous deposit with the new deposit amount to determine a total amount deposited by the user during the same calendar day;
determine that the total amount exceeds the threshold deposit amount;
request regulatory information of the user;
receive the regulatory information of the user;
process the deposit.

2. The system of claim 1, wherein the one or more processing devices are further configured to execute computer-readable program code to:
determine that the total amount deposited by the user during the same calendar day exceeds the regulatory amount; and
automatically transmit a report comprising the regulatory information of the user to the regulatory agency.

3. The system of claim 1, wherein the one or more processing devices are configured to execute computer-readable program code to determine the threshold deposit amount based on a percentage of or a predetermined amount less than the regulatory amount of deposited funds during any calendar day that triggers a requirement for a financial institution to notify a regulatory agency.

4. The system of claim 1, wherein the one or more processing devices are configured to execute computer-readable program code to determine the threshold deposit amount based on a deposit trend that indicates that the threshold deposit amount would be exceeded if the deposit trend continues.

5. The system of claim 1, wherein the one or more processing devices are configured to execute computer-readable program code to:
identify a first person on whose behalf the new deposit is being conducted;
identify a previous deposit for the first person by searching the deposit database, wherein the previous deposit occurred earlier on a same calendar day;
combine an amount of the previous deposit with the new deposit amount to determine a total amount deposited for the first person during the same calendar day;
determine that the total amount deposited for the first person exceeds the threshold deposit amount;
request regulatory information for the first person;
receive the regulatory information for the first person; and
process the deposit.

6. The system of claim 1, wherein the one or more processing devices are configured to execute computer-readable program code to:
identify a first account to which the new deposit is being conducted;
identify a previous deposit for the first account by searching the deposit database, wherein the previous deposit occurred earlier on a same calendar day;
combine an amount of the previous deposit with the new deposit amount to determine a total amount deposited for the first account during the same calendar day;
determine that the total amount deposited for the first account exceeds the threshold deposit amount;
request regulatory information associated with the first account;
receive the regulatory information associated with the first account; and
process the deposit.

7. The system of claim 1, wherein the one or more processing devices are configured to execute computer-readable program code to:
transmit a command to a user interface of a computing device at a location of the request for the new deposit, causing the user interface to display a selectable offer to open an investment account to which the deposit amount may be transferred;
receive an indication from the user interface that the user selected the offer; and
transmit the deposit amount to the investment account.

8. A computer program product for triggering alerts associated with deposit amounts, the computer program product comprising at least one non-transitory computer readable medium comprising computer readable instructions, the instructions comprising instructions for:
determining a threshold deposit amount based on a regulatory amount of deposited funds during any calendar day that triggers a requirement for a financial institution to notify a regulatory agency, wherein the threshold deposit amount is less than the regulatory amount;
receiving deposit data in real time and store the deposit data in a deposit database;
receiving a request for a new deposit associated with a new deposit amount and a user;
identifying a previous deposit by the user by searching the deposit database, wherein the previous deposit occurred earlier on a same calendar day;
combining an amount of the previous deposit with the new deposit amount to determine a total amount deposited by the user during the same calendar day;
determining that the total amount exceeds the threshold deposit amount;
requesting regulatory information of the user;
receiving the regulatory information of the user;
processing the deposit.

9. The computer program product of claim 8, wherein the computer readable instructions further comprise instructions for:
determining that the total amount deposited by the user during the same calendar day exceeds the regulatory amount; and
automatically transmitting a report comprising the regulatory information of the user to the regulatory agency.

10. The computer program product of claim 8, wherein the computer readable instructions further comprise instructions for determining the threshold deposit amount based on a percentage of or a predetermined amount less than the regulatory amount of deposited funds during any calendar day that triggers a requirement for a financial institution to notify a regulatory agency.

11. The computer program product of claim 8, wherein the computer readable instructions further comprise instructions for determining the threshold deposit amount based on a deposit trend that indicates that the threshold deposit amount would be exceeded if the deposit trend continues.

12. The computer program product of claim 8, wherein the computer readable instructions further comprise instructions for:
identifying a first person on whose behalf the new deposit is being conducted;
identifying a previous deposit for the first person by searching the deposit database, wherein the previous deposit occurred earlier on a same calendar day;
combining an amount of the previous deposit with the new deposit amount to determine a total amount deposited for the first person during the same calendar day;
determining that the total amount deposited for the first person exceeds the threshold deposit amount;
requesting regulatory information for the first person;
receiving the regulatory information for the first person; and
processing the deposit.

13. The computer program product of claim 8, wherein the computer readable instructions further comprise instructions for:
identifying a first account to which the new deposit is being conducted;
identifying a previous deposit for the first account by searching the deposit database, wherein the previous deposit occurred earlier on a same calendar day;
combining an amount of the previous deposit with the new deposit amount to determine a total amount deposited for the first account during the same calendar day;
determining that the total amount deposited for the first account exceeds the threshold deposit amount;
requesting regulatory information associated with the first account;
receiving the regulatory information associated with the first account; and
processing the deposit.

14. The computer program product of claim 8, wherein the computer readable instructions further comprise instructions for:
transmitting a command to a user interface of a computing device at a location of the request for the new deposit, causing the user interface to display a selectable offer to open an investment account to which the deposit amount may be transferred;
receiving an indication from the user interface that the user selected the offer; and
transmitting the deposit amount to the investment account.

15. A computer implemented method for triggering alerts associated with deposit amounts, said computer implemented method comprising:
providing a computing system comprising a computer processing device and a non-transitory computer readable medium, where the computer readable medium comprises configured computer program instruction code, such that when said instruction code is operated by said computer processing device, said computer processing device performs the following operations:
determining a threshold deposit amount based on a regulatory amount of deposited funds during any calendar day that triggers a requirement for a financial institution to notify a regulatory agency, wherein the threshold deposit amount is less than the regulatory amount;
receiving deposit data in real time and store the deposit data in a deposit database;
receiving a request for a new deposit associated with a new deposit amount and a user;
identifying a previous deposit by the user by searching the deposit database, wherein the previous deposit occurred earlier on a same calendar day;
combining an amount of the previous deposit with the new deposit amount to determine a total amount deposited by the user during the same calendar day;
determining that the total amount exceeds the threshold deposit amount;
requesting regulatory information of the user;
receiving the regulatory information of the user;
processing the deposit.

16. The computer implemented method of claim 15, further comprising:
determining that the total amount deposited by the user during the same calendar day exceeds the regulatory amount; and
automatically transmitting a report comprising the regulatory information of the user to the regulatory agency.

17. The computer implemented method of claim 15, further comprising:
determining the threshold deposit amount based on a percentage of or a predetermined amount less than the regulatory amount of deposited funds during any calendar day that triggers a requirement for a financial institution to notify a regulatory agency; or
determining the threshold deposit amount based on a deposit trend that indicates that the threshold deposit amount would be exceeded if the deposit trend continues.

18. The computer implemented method of claim 15, further comprising:
identifying a first person on whose behalf the new deposit is being conducted;
identifying a previous deposit for the first person by searching the deposit database, wherein the previous deposit occurred earlier on a same calendar day;
combining an amount of the previous deposit with the new deposit amount to determine a total amount deposited for the first person during the same calendar day;
determining that the total amount deposited for the first person exceeds the threshold deposit amount;
requesting regulatory information for the first person;
receiving the regulatory information for the first person; and
processing the deposit.

19. The computer implemented method of claim 15, further comprising:
identifying a first account to which the new deposit is being conducted;
identifying a previous deposit for the first account by searching the deposit database, wherein the previous deposit occurred earlier on a same calendar day;
combining an amount of the previous deposit with the new deposit amount to determine a total amount deposited for the first account during the same calendar day;
determining that the total amount deposited for the first account exceeds the threshold deposit amount;
requesting regulatory information associated with the first account;
receiving the regulatory information associated with the first account; and
processing the deposit.

20. The computer implemented method of claim 15, further comprising:
transmitting a command to a user interface of a computing device at a location of the request for the new deposit, causing the user interface to display a selectable offer to open an investment account to which the deposit amount may be transferred;
receiving an indication from the user interface that the user selected the offer; and
transmitting the deposit amount to the investment account.
